(19) United States
(12) Patent Application Publication
(10) Pub. No.: US 2010/0053058 A1
(43) Pub. Date: Mar. 4, 2010

(54) Display Device

(75) Inventors: Osamu Nagashima, Mobara (JP); Nobuyuki Ishige, Shirako (JP); Yasushi Sakurai, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/548,733

(22) Filed: Aug. 27, 2009

(30) Foreign Application Priority Data
Aug. 29, 2008 (JP) 2008-220624

(51) Int. Cl. G09G 3/36

(52) U.S. Cl. 345/98

(57) ABSTRACT

A display device in which a non-display region where drain lines, gate lines and pixels are not formed is formed at a portion within a display region which is constituted of a mass of the pixels, drain route-around lines and gate route-around lines are formed by routing the drain lines and the gate lines separated by the non-display region around the non-display region, a line width of at least one of the drain route-around line and the gate route-around line is set such that the line width at an intersecting portion where the drain route-around line and the gate route-around line intersect with each other differs from the line width at a non-intersecting portion.

The present application claims priority from Japanese application JP2008-220624 filed on Aug. 29, 2008, the content of which is hereby incorporated by reference into this application.

### BACKGROUND OF THE INVENTION

1. Field of the Invention

The present invention relates to a display device, and more particularly, for example, to an active-matrix-type display device which includes a non-display region such as a window portion in a display portion.

2. Description of the Related Art

As shown in FIG. 8A, for example, an active-matrix-type display device is configured such that, a plurality of gate lines GL which extends in the x direction and is arranged parallel to each other in the y direction, and a plurality of drain lines DL which extends in the y direction and is arranged parallel to each other in the x direction, and in respective regions surrounded by these gate lines GL and drain lines DL, a pixel which is constituted of at least a thin film transistor which is turned on in response to a scanning signal supplied from the gate line GL, and a pixel electrode to which a video signal is supplied from the drain line DL via the thin film transistor in an ON state is formed.

Due to such constitution, the respective pixels can be independently controlled, and an image can be displayed by these pixels. In such an image display, an electric field generated between the pixel electrode and a counter electrode is applied to liquid crystal sandwiched by two substrates which are arranged to face each other in an opposed manner, and the arrangement of liquid crystal molecules is controlled with this electric field thus controlling transmission quantity of an external light. Here, fixing of two substrates and hermetic filling of liquid crystal are performed by a first sealing material SL1 and a second sealing material SL2.

With respect to the display device having such a constitution, there has been known a display device which is configured such that in a portion of a display region AR which is formed of a mass of pixels, a window portion (non-display region) WD which is constituted of an opening (through hole) is formed so as to allow a user to see a back-surface side of the display device with naked eyes, for example.

Such a display device is mainly applied to or used in amusement equipment such as a pachinko gaming machine or a slot gaming machine so as to increase interests in the equipment. Such a display device is disclosed in JP-A-2005-46352, for example. JP-A-2005-46352 discloses a technique which establishes the electrical connection of respective separated signal lines by way of route-around lines which are formed in a state that the lines are routed around a hole which corresponds to the above-mentioned window portion and extend to regions of pixels (pixel regions).

However, when the route-around lines are formed in the pixel regions, there exists a possibility that the constitution of the pixels becomes complicated due to the lines, display quality is lowered due to parasitic capacitance between the route-around line and an electrode of each pixel or the like.

To cope with such a drawback, in a display device of the related art, as shown in FIG. 8A, drain lines DL and gate lines GL which are separated by a window portion (non-display region) WD are connected to corresponding drain lines DL and gate lines GL on an opposite side with respect to the window portion WD by way of route-around lines (drain route-around lines JDL and gate route-around lines JGL) formed around the window portion WD.

### SUMMARY OF THE INVENTION

Here, with respect to the display device having the opened window portion WD, the route-around lines the number of which is equal to the number of the drain lines DL and the gate lines GL separated by the window portion WD are formed around the window portion WD, and no pixels are arranged in a region where the route-around lines are formed. Accordingly, in the display device of the related art, to decrease an area of a region where the pixels are not arranged, the route-around lines are formed using a line having a smaller width than lines within the pixel region.

Accordingly, as shown in FIG. 8B and FIG. 8C, to compare an area of an intersecting portion of the drain line DL and the gate line GL in the display region with an area of an intersecting portion of the drain route-around line JDL and the gate route-around line JGL formed on a peripheral portion of a non-display region, the area of the intersecting portion of the lines in the display region is larger than the area of the intersecting portion of the route-around lines formed on the periphery of the non-display region. On the other hand, the drain line and the gate line are configured to intersect with each other at the intersecting portion by way of an insulation film and hence, parasitic capacitance which is formed attributed to the intersection of the respective signal lines (hereinafter referred to as intersecting-portion capacitance) is generated between the drain line and the gate line for every intersecting portion.

However, the drain line DL and the gate line GL which are separated by the window portion WD and, therefore, are connected with each other by the route-around line as described above generates, compared to the drain line DL and the gate line GL which are not separated, the decrease of intersecting-portion capacitance at the intersecting portion attributed to the use of the route-around line. Accordingly, there arises a drawback that the drain line DL and the gate line GL which are separated exhibit an effective voltage different from an effective voltage of the drain line DL and the gate line GL which are not separated. This drawback gives rise to a drawback that the in-plane effective voltage difference arises within the display region AR. Further, along with the generation of the in-plane effective voltage difference, the brightness difference arises within the display region AR thus giving rise to a drawback that display irregularities are generated in the display region AR.

It is a merit of the present invention to provide a display device which can decrease in-plane effective voltage difference within a display region even when route-around lines are used along with the formation of a window portion WD in a portion of a display area.

It is another merit of the present invention to provide a display device which can reduce brightness irregularities within the display region even when the route-around lines are used along with the formation of the window portion WD in the portion of the display area.

FIG. 7 is a view for explaining a case in which an intermediate grayscale image in which brightness difference on a screen is conspicuously displayed as display irregularities is displayed in a normally-white liquid crystal display device PNL. As can be clearly understood from FIG. 7, a drain line DL or a gate line GL is separated by a window portion WD. In regions indicated by A to D where the drain line DL or the gate line GL is separated by a window portion WD and separated drain lines DL or the separated gate lines GL are connected with each other via a route-around line, the intersecting-portion capacitance is small and hence, an effective voltage becomes higher than a desired voltage whereby desired brightness cannot be acquired leading to a dark display. On the other hand, in regions indicated by a to d where the drain line DL or the gate line GL is not separated, desired brightness can be acquired leading to a display with original intermediate grayscale brightness. When a normally-black liquid crystal display device is used, the above-mentioned bright portion and dark portion are reversed so that the regions indicated by A to D are displayed with brightness higher than desired brightness, and the regions indicated by a to d are displayed with desired brightness.

To overcome the above-mentioned drawbacks, the present invention is constituted as follows.

(1) According to a first aspect of the present invention, there is provided a display device which forms a plurality of drain lines and a plurality of gate lines intersecting with the drain lines on a substrate, and defines regions surrounded by the drain lines and the gate lines as regions of pixels, wherein a non-display region where the drain lines, the gate lines and the pixels are not formed is formed at a portion within a display region which is constituted of a mass of the pixels, drain route-around lines and gate route-around lines are formed by routing the drain lines and the gate lines separated by the non-display region around the non-display region, a line width of at least one of the drain route-around line and the gate route-around line is set such that the line width at an intersecting portion where the drain route-around line and the gate route-around line intersect with each other differs from the line width at a non-intersecting portion, and assuming the line width of the drain line at the non-intersecting portion as a₁, the line width of the drain line at the intersecting portion as b₁, the line width of the drain route-around line at the non-intersecting portion as c₁, the line width of the drain route-around line at the intersecting portion as d₁, the line width of the gate line at the non-intersecting portion as a₂, the line width of the gate line at the intersecting portion as b₂, the line width of the gate route-around line at the non-intersecting portion as c₂, and the line width of the gate route-around line at the intersecting portion as d₂, a relationship of |a₁−c₁>|b₁−d₁| and/or a relationship of a₂−c₂>b₂−d₂| are/is established.

(2) According to a second aspect of the present invention, there is provided a display device which forms a plurality of drain lines and a plurality of gate lines intersecting with the drain lines on a substrate, and defines regions surrounded by the drain lines and the gate lines as regions of pixels, wherein a non-display region where the gate lines, the drain lines and the pixels are not formed is formed at a portion within a display region which is constituted of a mass of the pixels, drain route-around lines and gate route-around lines are formed by routing the drain lines and the gate lines separated by the non-display region around the non-display region, and a line width of the drain route-around line and a line width of the gate route-around line at an intersecting portion where the drain route-around line and the gate route-around line intersect with each other are respectively set larger than the line width of the drain route-around line and the line width of the gate route-around line at portions other than the intersecting portion.

(3) In the display device having the constitution (1) or (2), one route-around line out of the drain route-around line and the gate route-around line is formed in a bent shape in a region where a plurality of intersecting portions is arranged, and another route-around line is formed in a non-bent shape in the region where the plurality of intersecting portions is arranged, and the intersecting portions arranged adjacent to each other on said one route-around line are displaced from each other in the extending direction of said another route-around line.

(4) In the display device having the constitution (3), said one route-around line is bent in a stepwise manner extending in one direction in the region where the plurality of intersecting portions is arranged.

(5) In the display device having the constitution (3), said one route-around line is bent in a zigzag manner in the region where the plurality of intersecting portions is arranged.

(6) According to a third aspect of the present invention, there is provided a display device which forms a plurality of drain lines and a plurality of gate lines intersecting with the drain lines on a substrate, and defines regions surrounded by the drain lines and the gate lines as regions of pixels, wherein a non-display region where the gate lines, the drain lines and the pixels are not formed is formed at a portion within a display region which is constituted of a mass of the pixels, drain route-around lines and gate route-around lines are formed by routing the drain lines and the gate lines separated by the non-display region around the non-display region, a line width of the drain route-around line is smaller than a line width of the drain line, a line width of the gate route-around line is set smaller than a line width of the gate line, and the line width of the drain line and the line width of the gate line at an intersecting portion where the drain line and the gate line intersect with each other are respectively set smaller than the line width of the drain line and the line width of the gate line at portions other than the intersecting portion.

(7) In the display device having any one of the constitutions (1) to (6), the display device is a liquid crystal display device which includes another substrate arranged to face the substrate in an opposed manner with liquid crystal sandwiched therebetween, and the non-display region constitutes a window portion formed between the substrate and said another substrate and surrounded by a sealing material.

(8) In the display device having any one of the constitutions (1) to (7), the substrate has an opening at a position corresponding to the non-display region.

According to the display device of the present invention, the difference in intersecting-portion capacitance between the display region and the non-display region can be made small and hence, even when the route-around lines are used due to the formation of the window portion WD, it is possible to decrease in-plane effective voltage difference within the display region.

As a result, even when the route-around lines are used due to the formation of the window portion WD, it is possible to decrease brightness irregularities within the display region.

Other advantages of the present invention will become apparent from the description of the whole specification.

### BRIEF DESCRIPTION OF THE DRAWINGS

FIG. 1 is a view for explaining a display device of an embodiment 1 of the present invention;

FIG. 2 is a view for explaining the schematic constitution of a liquid crystal display device of the embodiment 1 of the present invention;

FIG. 3A to FIG. 3C are plan views showing one example of a pixel of the liquid crystal display device of the embodiment 1 of the present invention;

FIG. 4A and FIG. 4B are views for explaining the schematic constitution of a liquid crystal display device of an embodiment 2 which constitutes the display device to which the present invention is applied;

FIG. 5A and FIG. 5B are enlarged views of a portion indicated by symbol A in FIG. 4;

FIG. 6 is a view for explaining the schematic constitution of a liquid crystal display device of an embodiment 3 which constitutes the display device to which the present invention is applied;

FIG. 7 is a view for explaining a case in which an intermediate grayscale image is displayed in a conventional liquid crystal display device; and

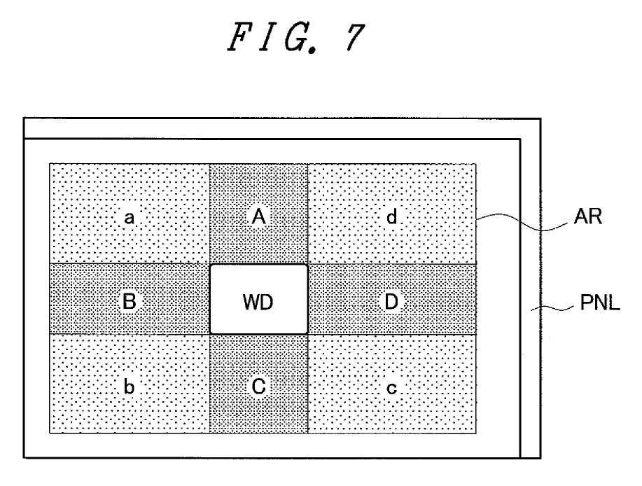

FIG. 8A to FIG. 8C is a view for explaining the schematic constitution of the conventional liquid crystal display device.

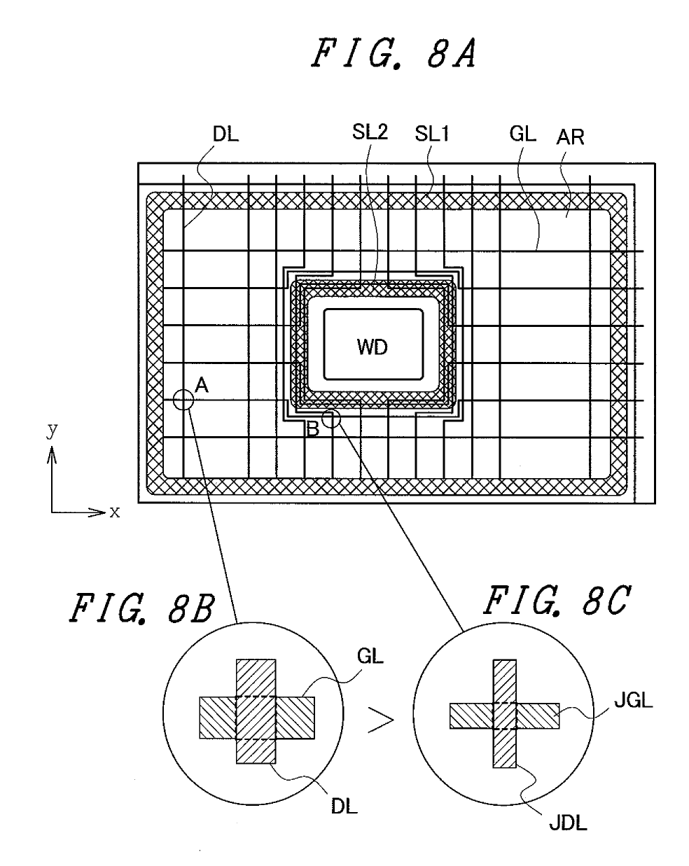

### DESCRIPTION OF THE PREFERRED EMBODIMENTS

Embodiments of a display device to which the present invention is applied are explained in conjunction with drawings. Here, in the explanation made hereinafter, identical constitutional elements are given same numerals and their repeated explanation is omitted.

### Embodiment 1

### Whole Constitution

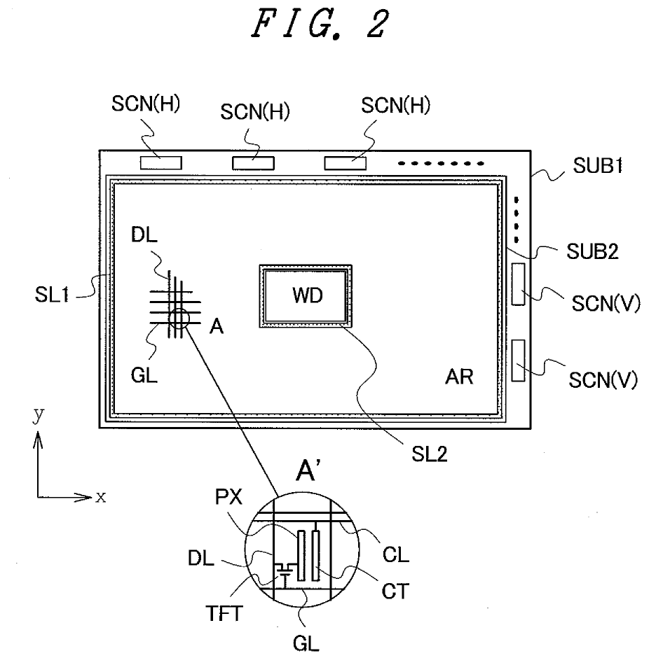

FIG. 2 shows a case in which a liquid crystal display device is taken as a display device to which the present invention is applied as an example, and FIG. 2 is also a view for explaining the schematic constitution of the liquid crystal display device according to the embodiment 1.

As can be clearly understood from FIG. 2, in a liquid crystal display device of an embodiment 1, a window portion (non-display region) WD constituted of an opening (through hole) is formed in a portion of a liquid crystal display region AR which is formed of amass of pixels. Due to such a constitution, for example, a user can observe a back-surface-side of the display device with his/her naked eyes.

Further, the liquid crystal display device of the embodiment 1 is constituted of a first substrate SUB1 on which pixel electrodes and the like are formed, a second substrate SUB2 which is arranged to face the first substrate SUB1 in an opposed manner, and a liquid crystal layer not shown in the drawing which is sandwiched between the first substrate SUB1 and the second substrate SUB2. Here, fixing of the first substrate SUB1 and the second substrate SUB2 to each other and sealing of liquid crystal which is sandwiched between the first substrate SUB1 and the second substrate SUB2 are carried out by a first seal member SL1 which is annularly applied to a peripheral portion of the second substrate SUB2 by coating and a second seal member SL2 which is annularly applied to a center portion of the liquid crystal display device by coating.

That is, in the liquid crystal display device of the embodiment 1, liquid crystal is hermetically filled in a region defined between the first seal member SL1 and the second seal member SL2, and this region forms the liquid crystal display region AR of the liquid crystal display device of the embodiment 1. However, even in the region where liquid crystal is hermetically filled, a region which does not form pixels therein and is irrelevant to the display is formed around (on an outer peripheral portion of) the window portion (non-display region) WD. In the region around the periphery of the window portion WD including a region where the second seal member SL2, route-around lines, that is, drain route-around lines JDL and gate route-around lines JGL are formed. Particularly, to satisfy a demand for narrowing of a region on the outer peripheral portion of the window portion WD which does not contribute to the display, the route-around lines (the drain route-around lines JDL and the gate route-around lines JGL) having small line widths are densely formed in such a region. Such a constitution contributes to narrowing of a picture frame of the window portion WD.

However, in the liquid crystal display device of the embodiment 1, as described later, line widths of the drain route-around line JDL and the gate route-around line JGL at an intersecting portion where the drain route-around line JDL and the gate route-around line JGL intersect with each other are respectively set larger than the line widths of the drain route-around line JDL and the gate route-around line JGL at portions other than the intersecting portion.

On the other hand, a region surrounded by the second seal member SL2 is a region in which liquid crystal is not filled. Particularly, in the embodiment 1, a hole is formed in a portion of the first substrate SUB1 and a portion the second substrate SUB2 which correspond to the window portion WD thus forming an opening. Here, it is not always necessary to form the hole in the window portion WD. For example, the window portion WD may be configured such that electrodes and the like are not formed on the window portion WD, and a display formed on a back surface of the window WD is observed with naked eyes by making use of light transmitting property of the first substrate SUB1 and the second substrate SUB2.

Gate lines GL which extend in the x direction and are arranged parallel to each other in the y direction in the drawing and drain lines DL which extend in the y direction and a rearranged parallel to each other in the x direction in the drawing are formed on a liquid-crystal-side surface of the first substrate SUB1 within the display region AR.

As described above, the drain lines DL are not formed on a portion where the window portion WD is formed, and pairs of drain lines wherein each pair of drain lines is physically separated by the window portion WD are formed on an upper side and a lower side of the window portion WD in the drawing. Each pair of separated drain lines DL is electrically connected with each other via the drain route-around line JDL which is formed around the window portion WD.

In the same manner as the drain lines DL, also the gate lines GL are not formed on a portion where the window portion WD is formed, and pairs of gate lines GL wherein each pair of gate lines GL is physically separated by the window portion WD are formed on a left side and a right side of the window portion WD in the drawing. Each pair of separated gate lines GL is also electrically connected with each other via the gate route-around line JGL which are formed around the window portion WD.

Since rectangular regions surrounded by the drain lines DL and the gate lines GL constitute regions where the pixels are formed, the respective pixels are arranged in a matrix array within the display region AR. Here, the pixels, the lines and the like are not formed on the window portion WD.

Each pixel includes, for example, as shown in an enlarged view A′ of a portion indicated by a circle A in the drawing, a thin film transistor TFT which is turned on in response to a scanning signal from the gate line GL, a pixel electrode PX to which a video signal from the drain line DL is supplied via the thin film transistor TFT which is in an ON state, and a counter electrode CT which is connected to a common line CL and to which a reference signal having a potential which becomes the reference with respect to a potential of the video signal is supplied.

For example, right ends of the respective gate lines GL extend over the first seal member SL1 and are respectively connected to negative output terminals of a corresponding semiconductor device SCN(V). Further, for example, upper ends of the respective drain lines DL extend over the first seal member SL1 and are respectively connected to negative output terminals of a corresponding semiconductor device SCN(H).

Here, the above-mentioned liquid crystal display device is configured such that a scanning signal drive circuit is constituted of a semiconductor device SCN(V) formed of a semiconductor chip, and a video signal drive circuit is constituted of a semiconductor device SCN(H) formed of a semiconductor chip, and the scanning signal drive circuit and the video signal drive circuit are formed on the surface of the first substrate SUB1. However, the scanning signal drive circuit and the video signal drive circuit may be provided such that one side of each semiconductor device formed by a tape carrier method or a COF (Chip On Film) method is connected to the first substrate SUB1. Further, the scanning signal drive circuit and the video signal drive circuit may be provided such that circuits are integrally incorporated into the first substrate SUB1.

### (Constitution of Pixel and Constitution of Intersecting Portion)

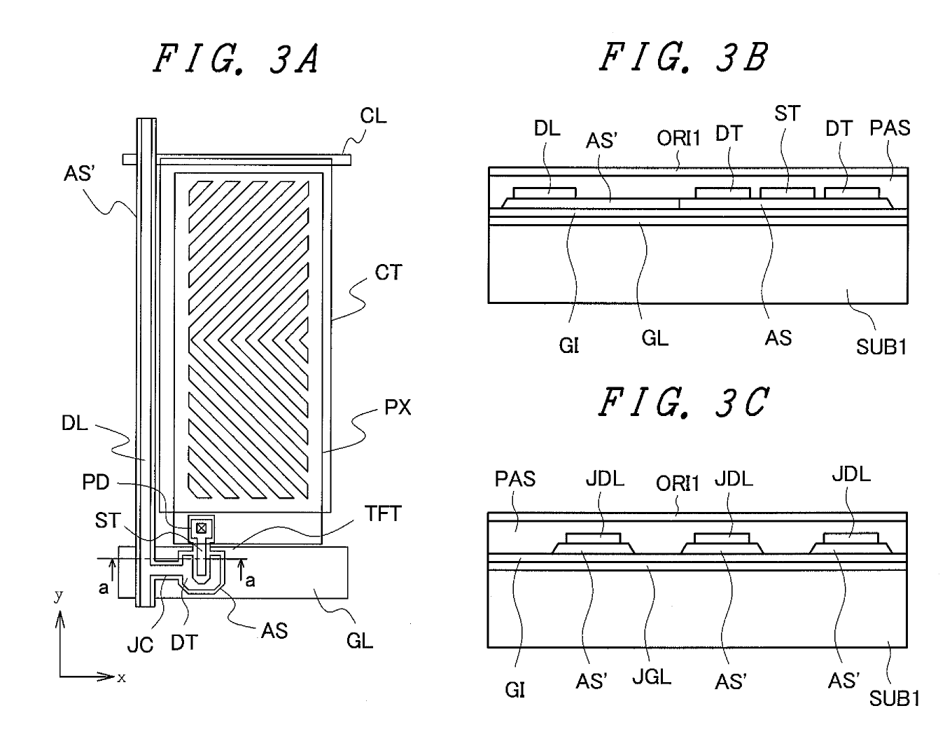

FIG. 3A is a plan view showing an embodiment of one pixel out of the respective pixels which are arranged in a matrix array on the first substrate SUB1 side of the liquid crystal display device.

First of all, the gate lines GL and the common lines CL are formed on a liquid-crystal-side surface (front surface) of the first substrate SUB1 parallel to each other at relatively large intervals.

A counter electrode CT which is made of a transparent conductive material such as ITO (Indium-Tin-Oxide), for example, is formed in the region defined between the gate line GL and the common line CL. The counter electrode CT has a peripheral portion thereof on a common-line-CL side formed over the common line CL in an overlapping manner and hence, the counter electrode CT is electrically connected to the common line CL.

Further, as shown in FIG. 3B which is a cross-sectional view taken along a line a-a in FIG. 3A, on a surface of the first substrate SUB1, an insulation film GI is formed in a state that the insulation film GI covers the gate lines GL, the common lines CL and the counter electrode CT. The insulation film GI functions as a gate insulation film for the thin film transistor TFT in a region where the thin film transistor TFT described later is formed, and a film thickness of the insulation film GI is determined based on the function of the insulation film GI.

An amorphous semiconductor layer AS made of amorphous silicon, for example, is formed on an upper surface of the insulation film GI at a position where the insulation film GI overlaps with a portion of the gate line GL. The semiconductor layer AS constitutes a semiconductor layer of the thin film transistor TFT.

Here, the semiconductor layer AS is, for example, in addition to the region where the thin film transistor TFT is formed, as indicated by symbol AS′ (hereinafter, described as an amorphous silicon layer), formed below the drain line DL, below a connection portion JC where the drain line DL and the drain electrode DT of the thin film transistor TFT are electrically connected with each other, and below a portion (including a pad portion PD) where a source electrode ST of the thin film transistor TFT extends over the region where the thin film transistor TFT is formed. Due to the provision of the semiconductor layer AS, for example, the drain line DL can be formed with a small step.

Further, the drain line DL is formed in a state that the drain line DL extends in the y direction in the drawing, the drain line DL forms an extending portion which extends toward a thin film transistor TFT side on a portion thereof, and the extending portion (connection portion JC) is connected to the drain electrode DT of the thin film transistor TFT which is formed on the semiconductor layer AS. Further, the drain line DL formed in an extending manner in the y direction in the drawing intersects with the gate line GL by way of the insulation film GI and the amorphous silicon layer AS′ in a region in the vicinity of the thin film transistor TFT.

Further, the source electrode ST which is formed simultaneously with the formation of the drain line DL and the drain electrode DT is formed in a state that the source electrode ST is arranged to face the drain electrode DT in an opposed manner on the semiconductor layer AS, and the source electrode ST includes an extending portion which slightly extends from the semiconductor layer AS to a pixel region side. The extending portion is configured to reach the pad portion PD explained later which is connected to the pixel electrode PX.

The drain electrode DT is formed into a U-shaped pattern so as to surround a distal end portion of the source electrode ST, for example. Due to such a constitution, a channel width of the thin film transistor TFT can be made large.

In forming the semiconductor layer AS on the insulation film GI, for example, a surface of the semiconductor layer AS is doped with high-concentration impurities, the drain electrode DT and the source electrode ST are formed by patterning, for example and, thereafter, a high-concentration impurity layer which is formed on regions other than the regions where the drain electrode DT and the source electrode ST are formed are removed by etching using a photoresist film formed on the drain electrode DT and the source electrode ST as a mask. Due to such a constitution, the high-concentration impurity layer remains between the semiconductor layer AS and the drain electrode DT as well as between the semiconductor layer AS and the source electrode ST thus forming an ohmic contact layer using the impurity layer.

By adopting such a constitution, the thin film transistor TFT is constituted of a transistor having the so-called inverse-staggered-type MIS (Metal Insulator Semiconductor) structure in which the gate signal line GL is used as a gate electrode.

Here, the transistor having the MIS structure is driven in such a manner the drain electrode DT and the source electrode ST are exchanged depending on an applied bias voltage. However, in the explanation of this specification, for convenience, an electrode which is connected to the drain line DL is referred to as a drain electrode DT, and an electrode which is connected to the pixel electrode PX is referred to as a source electrode ST.

On a surface of the first substrate SUB1, a protective film PAS which is formed of an insulation film is formed so as to cover the thin film transistor TFT. The protective film PAS is provided for preventing direct contact between the thin film transistor TFT and liquid crystal. Further, the protective film PAS is interposed between the counter electrode CT and the pixel electrode PX described later, and functions also as a dielectric film for a capacitive element which is formed between the counter electrode CT and the pixel electrode PX together with the insulation film GI.

The pixel electrodes PX are formed on an upper surface of the protective film PAS. The pixel electrode PX is formed of a transparent conductive film made of ITO (Indium-Tin-Oxide) or the like, for example, and the pixel electrode PX is formed in an overlapping manner with the counter electrode CT over a wide area.

Further, a large number of slits are formed in the pixel electrode PX in a state that these slits are arranged parallel to each other in the direction orthogonal to the longitudinal direction of the slits. Due to such a constitution, the pixel electrode PX is formed of a group of electrodes which is constituted of a large number of linear electrodes having respective both ends thereof connected with each other.

Here, as shown in FIG. 3A, the pixel region is vertically separated into two regions in the drawing for example, and each electrode of the pixel electrode PX is formed so as to extend in the direction which makes +45 degrees with respect to the running direction of the gate lines GL in one region of the pixel region, for example, and to extend in the direction which makes −45 degrees with respect to the running direction of the gate signal lines GL in another region of the pixel region, for example. That is, the pixel electrode PX adopts a so-called multi-domain method. When the direction of the slits (direction of a group of electrodes of the pixel electrode PX) formed in the pixel electrode PX within one pixel is only one direction, the colorination occurs depending on the viewing direction. The above-mentioned constitution adopting the multi-domain method can overcome this drawback.

The pixel electrode PX having such a constitution has a thin-film-transistor-TFT-side portion thereof electrically connected to the pad portion PD of the source electrode ST of the thin film transistor TFT via a through hole not shown in the drawing which is formed in the protective film PAS. Further, an alignment film ORI1 is formed on a surface of the first substrate SUB1 so as to cover also the pixel electrodes PX.

As described above, the respective pixel electrodes PX have a longitudinally elongated shape, that is, the respective pixel electrodes PX are formed in an elongated manner in the y direction which is the extending direction of the drain lines DL, and the respective pixels also have a longitudinally elongated shape.

On the other hand, as shown in FIG. 3C, with respect to the route-around lines formed on the peripheral region of the window portion WD, the gate route-around lines JGL are formed on a liquid-crystal-side surface of the first substrate SUB1, and an insulation film GI is formed on the gate route-around line JGL so as to cover the gate route-around line JGL.

On an upper surface of the insulation film GI and at a position where the insulation film GI overlaps with a portion of the gate route-around line JGL, an amorphous silicon layer AS′ is formed in the same manner as the constitution in the display region AR. Also in the amorphous silicon layer AS′ formed in the peripheral region of the window portion WD, the drain route-around line JDL is formed with a small step. Further, to decrease an ineffective region which does not contribute to the display in the peripheral region of the window portion WD, the drain route-around line JDL is formed on the amorphous silicon layer AS′ in a state that a line width of the drain route-around line JDL is set smaller than a line width of each drain line DL within the display region AR. In the same manner, a line width of the gate route-around line JGL is also set smaller than a line width of each gate line GL within the display region AR.

Further, the respective gate route-around lines JGL are formed by the same manufacturing steps as the gate lines GL. Accordingly, the gate route-around lines JGL and the gate lines GL are formed on the same layer and are formed using the same material, and have the same film thickness. In the same manner, the respective drain route-around lines JDL are also formed by the same manufacturing steps as the drain lines DL, and the drain route-around lines JDL and the drain lines DL are made of the same material and have the same film thickness, and are formed on the same layer.

### (Detailed Constitution of Drain Route-Around Lines and Gate Route-Around Lines)

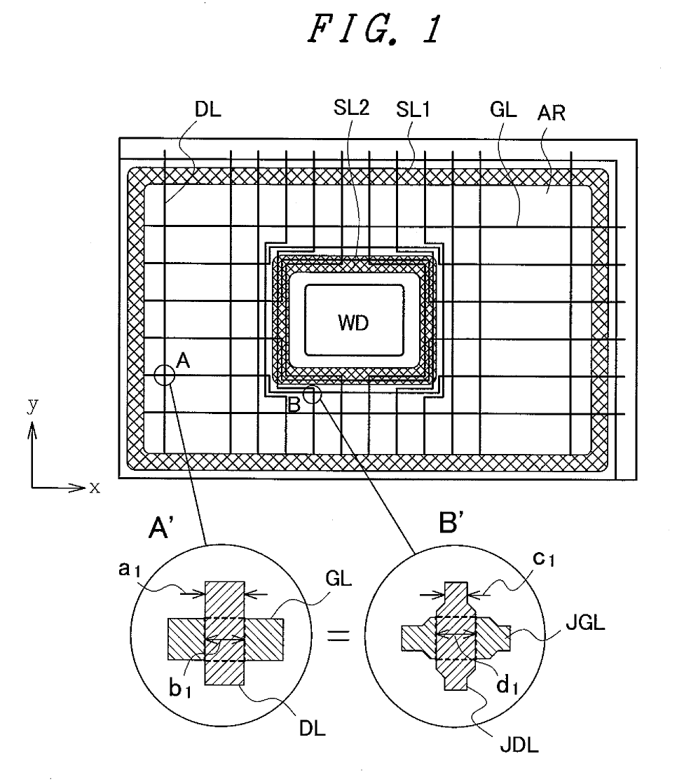

FIG. 1 is a plan view of the liquid crystal display device by taking out only the drain lines DL, the gate lines GL, the drain route-around lines JDL, and the gate route-around lines JGL within the region surrounded by the first seal member SL1 and the second seal member SL2.

In the region inside the first seal member SL1, the gate lines GL extend in the x direction and are arranged parallel to each other in the y direction in the drawing. However, the gate lines GL are not formed in the window portion WD surrounded by the second seal member SL2. Accordingly, the pairs of gate lines GL which are positioned on left and right sides of the window portion WD in the drawing are physically separated by the window portion WD.

Further, in the outer peripheral region of the window portion WD including the region where the second seal member SL2 is formed, the gate route-around lines JGL are formed so as to establish the electrical connection between the gate lines GL arranged on a left side in the drawing and the gate lines GL on a right side in the drawing with respect to the window portion WD.

Here, the display region AR is a region where the respective pixels are arranged in a matrix array. That is, the drain route-around lines JDL and the gate route-around lines JGL are formed in a region where the pixels are not formed. That is, on an upper portion and a lower portion of the outer peripheral portion of the second seal member SL2, the plurality of gate route-around lines JGL extends in the x direction in the drawing and is arranged parallel to each other in the y direction in the drawing. The number of gate route-around lines JGL is set at least equal to the number of gate lines GL which are separated by the window portion WD. Here, in this embodiment, the separated gate lines GL are vertically divided into two groups, that is, into upper and lower groups. The gate route-around lines JGL corresponding to the respective gate lines GL which belong to the upper group are formed on an upper side of the window portion WD, and the gate route-around lines JGL corresponding to the respective gate lines GL which belong to the lower group are formed on a lower side of the window portion WD. Here, as described above, the respective gate route-around lines JGL are formed by the same manufacturing steps as the gate lines GL and hence, the gate route-around lines JGL and the gate lines GL are formed on the same layer, and the gate route-around lines JGL and the gate lines GL are made of the same material and have the same film thickness. Here, the present invention is also applicable to the constitution in which the gate route-around lines JGL are formed on a layer different from a layer on which the gate lines GL are formed and the gate lines GL and the gate route-around lines JGL are connected with each other via contact holes.

Out of the respective gate route-around lines JGL, the gate route-around lines JGL which belong to the upper group, as shown in FIG. 1, have right end sides thereof bent in the downward direction, have bent portions thereof extended in the y direction in the drawing within a region on a right side of the window portion WD in the drawing, and have extending portions thereof respectively connected to the separated gate lines GL on one side. Further such gate route-around lines JGL have left side ends thereof bent in the downward direction, have bent portions thereof extended in the y direction in the drawing within a region on a left side of the window portion WD in the drawing, and have extending portions thereof respectively connected to the separated gate lines GL on another side. In the same manner as described above, out of the respective gate route-around lines JGL, the gate route-around lines JGL which belong to the lower group have right end sides thereof bent in the upward direction, have bent portions thereof extended in the y direction in the drawing within a region on a right side of the window portion WD in the drawing, and have extending portions thereof respectively connected to the separated gate lines GL on one side. Further, such gate route-around lines JGL have left side ends thereof bent in the upward direction, have bent portions thereof extended in the y direction in the drawing within a region on a left side of the window portion WD in the drawing, and have extending portions thereof respectively connected to the separated gate lines GL on another side.

In the same manner, the drain lines DL are also formed in the display region AR in a state that the drain lines DL extend in the y direction and are arranged parallel to each other in the x direction in the drawing but are not formed in the window portion WD. That is, the pairs of drain lines DL which are positioned on an upper side and a lower side of the window portion WD in the drawing are physically separated by the window portion WD.

Further, in the peripheral region of the window portion WD, the drain route-around lines JDL are formed so as to establish the electrical connection between the drain lines DL arranged on an upper side of the window portion WD in the drawing and the drain lines DL arranged on a lower side of the window portion WD in the drawing. In the regions on a left side and a right side of the window portion WD in the drawing, the plurality of drain route-around lines JDL is formed in a state that the drain route-around lines JDL extend in the y direction and are arranged parallel to each other in the x direction in the drawing. The number of drain route-around lines JDL is set at least equal to the number of drain lines DL which are separated by the window portion WD. Further, the respective drain route-around lines JDL are formed by the same manufacturing steps as the drain lines DL and hence, the drain route-around lines JDL and the drain lines DL are formed on the same layer, and the drain route-around lines JDL and the drain lines DL are made of the same material and have the same film thickness.

Further, the drain route-around lines JDL which belong to a right group have upper end sides thereof bent in the drawing, have bent portions thereof extended in the x direction in the drawing on an upper side of the window portion WD in the drawing, and have extending portions thereof respectively connected to the separated drain lines DL on one side. Further, these drain route-around lines JDL have lower end sides thereof bent in the drawing, have bent portions thereof extended in the x direction in the drawing on a lower side of the window portion WD in the drawing, and have extending portions thereof respectively connected to the separated drain lines DL on another side. The drain route-around lines JDL which belong to a left group are also connected to the drain lines DL in the same manner as described above.

Then, in the liquid crystal display device of the embodiment 1, as shown in an enlarged view A′ of a portion indicated by a circle A in the drawing, the line width of the drain route-around line JDL and the line width of gate route-around line JGL at the intersecting portion where the drain route-around line JDL and the gate route-around line JGL intersect with each other are respectively set larger than the line width of the drain route-around line JDL and the line width of the gate route-around line JGL at portions other than the intersecting portion. Here, in the embodiment 1, although both the line widths of the drain route-around line JDL and the gate route-around line JGL at the intersecting portion are set larger than the line widths of the respective route-around lines JDL, JGL at portions other than the intersecting portion, the present invention is not limited to such a constitution. That is, the present invention may adopt the constitution in which the line width at the intersecting portion is larger than the line width of at portions other than the intersecting portion with respect to at least one of the drain route-around line JDL and the gate route-around line JGL.

Further, in the liquid crystal display device of the embodiment 1, the line widths of the drain route-around line JDL and the gate route-around line JGL at the intersecting portion are determined so as to set an intersecting area of the intersecting portion of the drain line DL and the gate line GL within the display region AR and an intersecting area of the intersecting portion of the drain route-around line JDL and the gate route-around line JGL equal. For example, assuming a line width of the drain line DL at portions other than the intersecting portion as a₁, a line width of the drain line DL at the intersecting portion as b₁, a line width of the drain route-around line JDL at portions other than the intersecting portion as c₁, a line width of the drain route-around line JDL at the intersecting portion as d₁, a line width of the gate line GL at portions other than the intersecting portion as a₂, a line width of the gate line GL at the intersecting portion as b₂, a line width of the gate route-around line JGL at portions other than the intersecting portion as c₂, and a line width of the gate route-around line JGL at the intersecting portion as d₂, the respective line widths are determined so as to establish the relationship of a₁=b₁=d₁, and the relationship of a₂=b₂=d₂. Further, the drain line DL and the gate line GL orthogonally intersect with each other at the intersecting portion, and the drain route-around line JDL and the gate route-around line JGL orthogonally intersect with each other at the intersecting portion. Accordingly, it is possible to set the intersecting-portion capacitance generated at the intersecting portion of the signal lines DL, GL within the display region AR and the intersecting-portion capacitance at the intersecting portion of the route-around lines JDL, JGL within the periphery of the window portion WD equal.

However, the present invention is not limited to the above-mentioned constitution. Even when the intersecting-portion capacitance at the intersecting portion of the lines DL, GL and the intersecting-portion capacitance at the intersecting portion of the route-around lines JDL, JGL are not completely equal, there arises no problem in practical use so long as it is possible to approximate these intersecting-portion capacitances to each other.

For example, when the line width d₁ of the drain route-around line JDL at the intersecting portion is set larger than the line width c₁ of the drain route-around line JDL at positions other than the intersecting portion, it is possible to approximate the intersecting-portion capacitance at the intersecting portion of the route-around lines JDL, JGL more to the intersecting-portion capacitance at the intersecting portion of the lines DL, GL in the display region A than the conventional constitution. That is, it is possible to decrease the difference between the intersecting-portion capacitance in the display region AR and the intersecting-portion capacitance in the non-display region NAR.

In the same manner, when the line width d₂ of the gate route-around line JGL at the intersecting portion is set larger than the line width c₂ of the gate route-around line JGL at portions other than the intersecting portion, it is possible to approximate the intersecting-portion capacitance at the intersecting portion of the route-around lines JDL, JGL more to the intersecting-portion capacitance at the intersecting portion of the lines DL, GL in the display region AR than the conventional constitution. That is, it is possible to decrease the difference between the intersecting-portion capacitance in the display region AR and the intersecting-portion capacitance in the non-display region NAR.

In this manner, to compare an absolute value of difference between the line width of the drain line DL and the line width of the drain route-around line JDL at the intersecting portion with an absolute value of difference between the line width of the drain line DL and the line width of the drain route-around line JDL at portions other than the intersecting portion, when the absolute value of difference between the line widths at the intersecting portion is smaller than the absolute value of difference between the line widths at portions other than the intersecting portion (when these absolute values of difference satisfy the following formula 1), the intersecting-portion capacitance at the intersection of the drain route-around line JDL and the gate route-around line JGL approximates the intersecting-portion capacitance at the intersection of the drain line DL and the gate line GL within the display region AR more than the conventional constitution and hence, it is possible to decrease the difference between the intersecting-portion capacitance at the intersection of the signal lines within the display region AR and the intersecting-portion capacitance at the intersection of the route-around lines.

|a₁−c₁|>|b₁−d₁| (formula 1)

In the same manner as described above, to compare an absolute value of difference between the line width of the gate line GL and the line width of the gate route-around line JGL at the intersecting portion with an absolute value of difference between the line width of the gate line GL and the line width of the gate route-around line JGL at portions other than the intersecting portion, when the absolute value of difference between the line widths at the intersecting portion is smaller than the absolute value of difference between the line widths at portions other than the intersecting portion (when these absolute values of difference satisfy the following formula 2), the intersecting-portion capacitance at the intersection of the drain route-around line JDL and the gate route-around line JGL approximates the intersecting-portion capacitance at the intersection of the drain line DL and the gate line GL within the display region AR more than the conventional constitution and hence, it is possible to decrease the difference between the intersecting-portion capacitance at the intersection of the signal lines within the display region AR and the intersecting-portion capacitance at the intersection of the route-around lines.

|a₂−c₂|>|b₂−d₂| (formula 2)

Here, when both of the formulae 1, 2 are satisfied, both line widths of the drain route-around line JDL and the gate route-around line JGL at the intersecting portion are set larger than the line widths of the drain route-around line JDL and the gate route-around line JGL at portions other than the intersecting portions and hence, it is possible to further decrease the difference between the intersecting-portion capacitance at the intersecting portion of the signal lines within the display region AR and the intersecting-portion capacitance at the intersecting portion of the route-around lines.

As a result, even when the route-around lines (the drain route-around lines JDL and the gate route-around line JGL) are used along with the formation of the window portion WD, the in-plane effective voltage difference within the display region AR can be decreased thus reducing the brightness irregularities within the display region AR.

Further, compared to the above-mentioned case in which the drain lines DL and the gate lines GL orthogonally intersect with each other and the drain route-around lines JDL and the gate route-around lines JGL orthogonally intersect with each other as shown in an enlarged view A′ of a portion indicated by a circle A and an enlarged view B′ of a portion indicated by a circle B in the drawing, there may be a case where the drain lines DL, the gate lines GL, the drain route-around line JDL and the gate route-around line JGL are formed such that the lines DL, GL do not intersect with each other orthogonally but intersect with each other obliquely, and the route-around lines JDL, JGL do not intersect with each other orthogonally but intersect each other obliquely. In such a case, areas of intersecting regions are changed depending on an inclination angle even when the respective lines have the same line width. Accordingly, in the liquid crystal display device having such a constitution, the line widths may be determined by taking not only the line widths but also the inclination angle of the lines at the intersecting region into consideration. That is, the line widths may be determined by taking the line widths and the inclination angle of the drain route-around line JDL and the gate route-around line JGL in the intersecting region into consideration. Also in this case, in the same manner as the above-mentioned case where the respective lines orthogonally intersect with each other, even when the route-around lines (the drain route-around lines JDL and the gate route-around lines JGL) are used along with the formation of the window portion WD, it is possible to decrease the in-plane effective voltage difference within the display region AR thus reducing the brightness irregularities within the display region AR.

### Embodiment 2

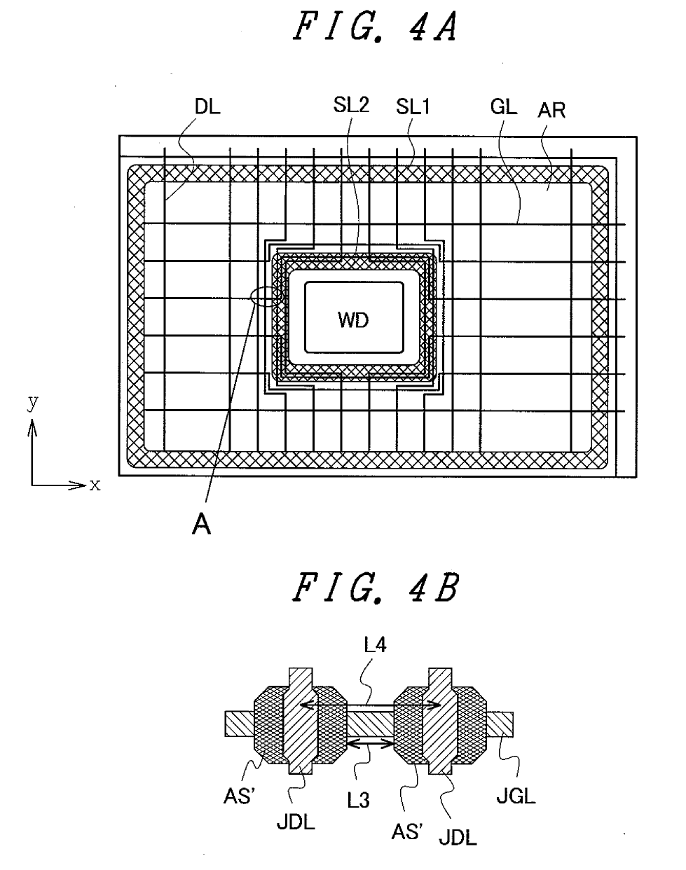

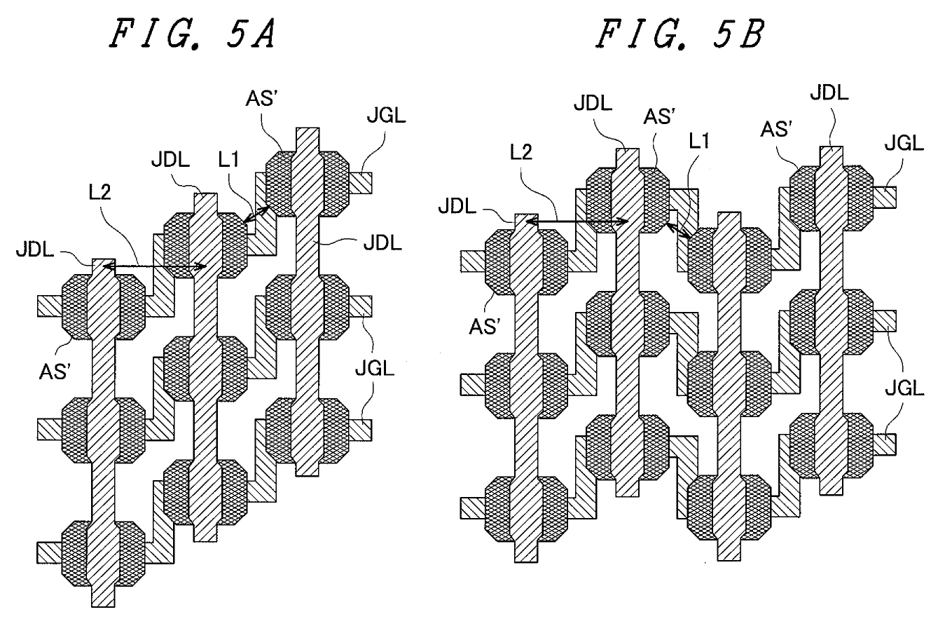

FIG. 4A and FIG. 4B are views for explaining the schematic constitution of the liquid crystal display device of an embodiment 2 which constitutes the display device to which the present invention is applied, and FIG. 5A and FIG. 5B are enlarged views of an portion A in FIG. 4A. Here, FIG. 4A is a plan view of the liquid crystal display device of the embodiment 2 in which only drain lines DL, gate lines GL, drain route-around line JDL, and gate route-around line JGL are depicted, and FIG. 4B is a view for explaining one example of intersecting portions of drain route-around lines JDL and a gate route-around line JGL. Here, in FIG. 4B, FIG. 5A and FIG. 5B, an amorphous silicon layer AS′ is also shown.

The liquid crystal display device shown in FIG. 4A and FIG. 4B has the same constitution as the liquid crystal display device of the embodiment 1 except for the constitution of the drain route-around lines JDL and the gate route-around lines JGL which are formed in a peripheral region of a window portion WD. Accordingly, in the explanation hereinafter, the constitution of the drain route-around line JDL and the gate route-around line JGL is explained in detail.

In the same manner as the liquid crystal display device of the embodiment 1, also in the liquid crystal display device of the embodiment 2, the gate lines GL which are arranged above the center of the window portion WD and are laterally separated in the drawing by way of the window portion WD are electrically connected with each other by the gate route-around lines JGL which are formed in a region above the window portion WD. On the other hand, the gate lines GL which are arranged below the center of the window portion WD and are laterally separated in the drawing by the window portion WD are electrically connected with each other by way of the gate route-around lines JGL which are formed in a region below the window portion WD.

Further, the drain lines DL which are arranged on a right side of the center of the window portion WD and are vertically separated in the drawing by the window portion WD are electrically connected with each other by way of the drain route-around lines JDL which are formed in a region on a right side of the window portion WD. Further, the drain lines DL which are arranged on a left side of the center of the window portion WD and are vertically separated in the drawing by the window portion WD are electrically connected with each other by way of the drain route-around lines JDL which are formed in a region on a left side of the window portion WD.

Also in the liquid crystal display device of the embodiment 2, for decreasing the difference between intersecting-portion capacitance at an intersecting portion of the drain route-around line JDL and the gate route-around line JGL and intersecting-portion capacitance at an intersecting portion of the drain line DL and the gate line GL within the display region AR, at the intersecting portion of the drain route-around line JDL and the gate route-around line JGL, the line widths of the respective route-around lines JDL, JGL and the line widths of the respective lines DL, GL within the display region AR are set equal (as has been explained in conjunction with the embodiment 1, not being always necessary to set the line widths of the respective route-around lines JDL, JGL and the line widths of the respective lines DL, GL equal so long as the line widths of the respective route-around lines JDL, JGL approximate the line widths of the respective lines DL, GL within the display region AR).

As shown in FIG. 5A, in the liquid crystal display device of the embodiment 2, the gate route-around lines JGL are bent such that intersecting portions of the drain route-around lines JDL and each gate route-around line JGL are arranged in a stepwise manner. Here, the line to be bent is not limited to the gate route-around lines JGL, and the drain route-around line JDL or both of the gate route-around line JGL and the drain route-around line JDL may be bent. Particularly, in the liquid crystal display device of the embodiment 2, as described above, the pixel has a longitudinally elongated shape (elongated in the y direction) and hence, the number of gate lines GL which are separated by the window portion WD becomes smaller than the number of drain lines DL which are separated by the window portion WD and hence, this embodiment adopts the constitution which bends the gate route-around lines JGL. Due to such a constitution, it is possible to narrow the intervals of the drain route-around lines JDL the number of which is larger than the number of the gate route-around lines JGL and hence, this embodiment is more advantageous effect in decreasing the difference between intersecting-portion capacitance at an intersecting portion of the drain route-around line JDL and the gate route-around line JGL and intersecting-portion capacitance at an intersecting portion of the drain line DL and the gate line GL within the display region AR.

Hereinafter, the detailed constitution of the liquid crystal display device of the embodiment 2 is explained in detail in conjunction with FIG. 4 and FIG. 5.

Usually, with respect to a region which is occupied by the route-around lines formed on a periphery of the window portion WD, it is desirable to decrease an area of such a region to impart feeling of integrity between a structural body in which the window portion WD is arranged and a display screen. Accordingly, it is desirable to set the line width of the drain route-around line JDL, the line width of the gate route-around line JGL and an interval between neighboring amorphous silicon layers AS′ in accordance with minimum rules. However, to enhance the reliability of the liquid crystal display device by preventing the occurrence of breaking of the line at the intersecting portion, it is desirable to form a semiconductor layer such as the amorphous silicon layer AS′ on the intersecting portion where the drain route-around line JDL and the gate route-around line JGL intersect with each other.

For this end, as in the case of an example of the intersection portion shown in FIG. 4B, when the drain route-around line JDL intersects with the gate route-around line JGL, an interval L4 between the drain route-around lines JDL which are arranged adjacent to and parallel to each other is set larger than an interval L3 in accordance with minimum rules even when the neighboring amorphous silicon layers AS′ are arranged at such an interval L3 in accordance with the minimum rule.

On the other hand, in the liquid crystal display device of the embodiment 2, the gate route-around lines JGL which are arranged adjacent to and parallel to each other as shown in FIG. 5A are bent in a stepwise manner extending in one direction (for example, in the oblique upward direction). In this case, the intersecting portions of the drain route-around lines JDL and the gate route-around lines JGL are arranged displaced form each other in a stepwise manner and hence, amorphous silicon layers AS′ arranged adjacent to each other on one gate route-around line JGL are formed displaced from each other in the oblique direction. Accordingly, when the amorphous silicon layers AS′ are formed in an island shape at intervals L1 (equal to the intervals L3 of minimum rule), the drain route-around lines JDL can be formed at intervals L2 smaller than intervals L4 shown in FIG. 4B.

Hereinafter, the constitution shown in FIG. 5A is explained in detail.

In the same manner as the liquid crystal display device of the embodiment 1, the liquid crystal display device of the embodiment 2 is configured using the center position of the window portion WD as the reference, wherein the gate route-around lines JGL which are connected to the gate lines GL formed on an upper side of the center position of the window portion WD in the drawing are routed around an upper side of the window portion WD and are electrically connected to other gate lines GL. On the other hand, the gate route-around lines JGL which are connected to the gate lines GL formed on a lower side of the center position of the window portion WD in the drawing are routed around a lower side of the window portion WD and are electrically connected to other gate lines GL.

In the embodiment 2, the bending direction of the gate route-around line JGL is adjusted corresponding to the route around direction of the gate route-around line JGL. Accordingly, the gate route-around line JGL positioned above the center position of the window portion WD is formed by bending in the oblique upward direction in the drawing as can be clearly understood from a position of circled A shown in FIG. 4A.

That is, the gate route-around line on a left upper portion of the window portion WD intersects with the drain route-around line JDL by way of the amorphous silicon layer AS′ and, thereafter, a portion of a non-intersecting portion of the gate route-around line JGL is bent such that the portion extends in the direction parallel to the extending direction of the drain route-around line JDL and upwardly (implying the upward direction in the drawing). Next, the gate route-around line JGL bent upwardly is again bent in the direction orthogonal to the drain route-around line JDL. Due to such bending, the bent gate route-around line JGL is configured to intersect with the next drain route-around line JDL by way of the amorphous silicon layer AS′. Hereinafter, bending of the gate route-around line JGL upwardly and bending of the gate route-around line JGL in the direction toward the drain route-around line JDL are repeated thus forming the gate route-around line JGL (forming the gate route-around line JGL such that the gate route-around line JGL extends in one direction (the right upper direction in the drawing) and bending in a stepwise manner). Accordingly, the intersecting portions of the drain route-around lines JDL and the gate route-around lines JGL are arranged displaced from each other in a stepwise manner.

Further, in the same manner, the gate route-around line on a left lower portion of the window portion WD intersects with the drain route-around line JDL by way of the amorphous silicon layer AS′ and, thereafter, a portion of a non-intersecting portion of the gate route-around line JGL is bent such that the portion extends in the direction parallel to the extending direction of the drain route-around line JDL and downwardly (implying the downward direction in the drawing). Next, the gate route-around line JGL bent downwardly is again bent in the direction orthogonal to the drain route-around line JDL. Due to such bending, the bent gate route-around line JGL is configured to intersect with the next drain route-around line JDL by way of the amorphous silicon layer AS′. Hereinafter, bending of the gate route-around line JGL downwardly and bending of the gate route-around line JGL in the direction toward the drain route-around line JDL are repeated thus forming the gate route-around line JGL (forming the gate route-around line JGL such that the gate route-around line JGL extends in one direction (the right lower direction in the drawing) and are bent in a stepwise manner). Accordingly, the intersecting portions of the drain route-around lines JDL and the gate route-around lines JGL are arranged displaced from each other in a stepwise manner.

The route-around lines in a region on a right side of the window portion WD also have the same constitution described above in the vertical direction only except for that the bending direction of the gate route-around lines JGL becomes reverse in the lateral direction and hence, the detailed explanation of such route-around lines is omitted.

In this manner, according to the embodiment 2, the gate route-around lines JGL are formed such that the gate route-around lines JGL extend in one direction and are bent in a stepwise manner and hence, the intersecting portions of the drain route-around lines JDL and the gate route-around lines JGL are arranged displaced from each other in a stepwise manner, and the amorphous silicon layers AS′ arranged adjacent to each other are formed displaced from each other in the oblique direction.

Accordingly, when a minimum rule is adopted, even when the interval L1 between the neighboring amorphous silicon layers AS′ is equal to the interval L3 shown in FIG. 4B, the interval L2 in the horizontal direction, that is, in the x direction can be set smaller (narrower) than the interval L4 shown in FIG. 4B. As a result, the interval L2 between the drain route-around lines JDL which are formed above these amorphous silicon layers AS′ can be also made small and hence, a region extending in the x direction, that is, in the lateral direction for the route-around lines which occupy the periphery of the window portion WD can be made small.

In the same manner, also with respect to a region of the window portion WD extending in the vertical direction, by bending the drain route-around line JDL and by arranging the amorphous silicon layers AS′ displaced from each other in a stepwise manner, a region in the vertical direction within a region which occupies the periphery of the window portion WD can be made small (narrowed). In this case, the gate route-around line JGL is not bent in the region where the intersecting portions are arranged parallel to each other.

In the above-mentioned explanation, the constitution in which the intersecting portions are arranged displaced from each other in a stepwise manner by setting the bending direction of the route-around line to the fixed direction is adopted. However, the present invention is not limited to such a constitution. For example, as shown in FIG. 5B, the present invention may adopt the constitution in which the neighboring intersecting portions are alternately arranged in the vertical direction (the constitution in which the intersecting portions are arranged parallel to each other in a zigzag manner).

Hereinafter, such a constitution is explained in detail in conjunction with FIG. 5B.

As shown in FIG. 5B, also with respect to the constitution in which gate route-around lines JGL are bent in a zigzag manner, intersecting portions of the drain route-around lines JDL and the gate route-around lines JGL on one gate route-around line JGL are arranged displaced from each other in a zigzag manner and hence, neighboring amorphous silicon layers AS′ are formed displaced from each other in the oblique direction.

Here, FIG. 5B shows the example in which the gate route-around lines JGL are formed in a zigzag manner. However, the present invention is not limited to such an example, and the drain route-around lines JDL may be formed in a zigzag manner.

As has been explained above, in the liquid crystal display device of the embodiment 2, the respective line widths of the drain route-around line JDL and the gate route-around line JGL at the intersecting portion where the drain route-around line JDL and the gate route-around line JGL intersect with each other are set in the same manner as the liquid crystal display device of the embodiment 1. That is, to set the intersecting area at the intersecting portion of the drain line DL and the gate line GL within the display region AR and the intersecting area at the intersecting portion of the drain route-around line JDL and the gate route-around line JGL equal, the respective line widths of the drain route-around line JDL and the gate route-around line JGL at the intersecting portion where the drain route-around line JDL and the gate route-around line JGL intersect with each other are set larger than line widths of the drain route-around line JDL and the gate route-around line JGL at portions other than the intersecting portions and, at the same time, such line widths are respectively set equal to the line widths of the corresponding drain line DL and the gate line GL within the display region AR. Accordingly, the intersecting-portion capacitance of the signal line in the display region AR and the intersecting portion capacitance of the route-around line on the periphery of the window portion WD can be set equal.

As a result, even when the route-around lines (the drain route-around lines JDL and the gate route-around line JGL) are used along with the formation of the window portion WD, the in-plane effective voltage difference within the display region AR can be decreased thus reducing the brightness irregularities within the display region AR.

In addition to the above-mentioned constitution, in the liquid crystal display device of the embodiment 2, the intersecting portions are arranged displaced from each other by setting the bending direction of the route-around line to the fixed direction or by setting the bending direction of the route-around line in a zigzag manner. Accordingly, in addition to the above-mentioned advantageous effects, it is possible to prevent the increase of intervals of the route-around lines attributed to the increase of the line width of the route-around lines at the intersecting portion compared to the line width of the route-around lines at portions other than the intersecting portion or the formation of amorphous silicon layers AS′ in an island shape at intersecting portions of the route-around lines.

When the drain lines DL and the gate lines GL are formed so as to intersect with each other in an inclined manner instead of being orthogonal to each other and the drain route-around lines JDL and the gate route-around lines JGL are formed so as to intersect with each other in an inclined manner instead of being orthogonal to each other, areas of intersecting regions are changed depending on an inclined angle even these lines have the same width. Accordingly, in such a case, the line widths may be determined by taking not only the line widths but also the inclination angle of the lines at the intersecting region into consideration. That is, the line widths may be determined by taking the line widths and the inclination angle of the drain route-around line JDL and the gate route-around line JGL within the intersecting region into consideration.

Further, the present invention is not limited to the case where the intersecting portion capacitance of the signal line in the display region AR and the intersecting portion capacitance of the route-around line on the periphery of the window portion WD are set equal. That is, the present invention is also applicable to a case where both intersecting portion capacitances are different from each other but are close to each other to an extent that brightness irregularities do not become conspicuous. Accordingly, also in the embodiment 2, the line width of the drain line DL, the line width of the drain route-around line JDL at the intersecting portion, the line width of the gate line GL and the line width of the gate route-around line JGL may be set to any values provided that the formula 1 and/or the formula 2 of the embodiment 1 are/is satisfied.

### Embodiment 3

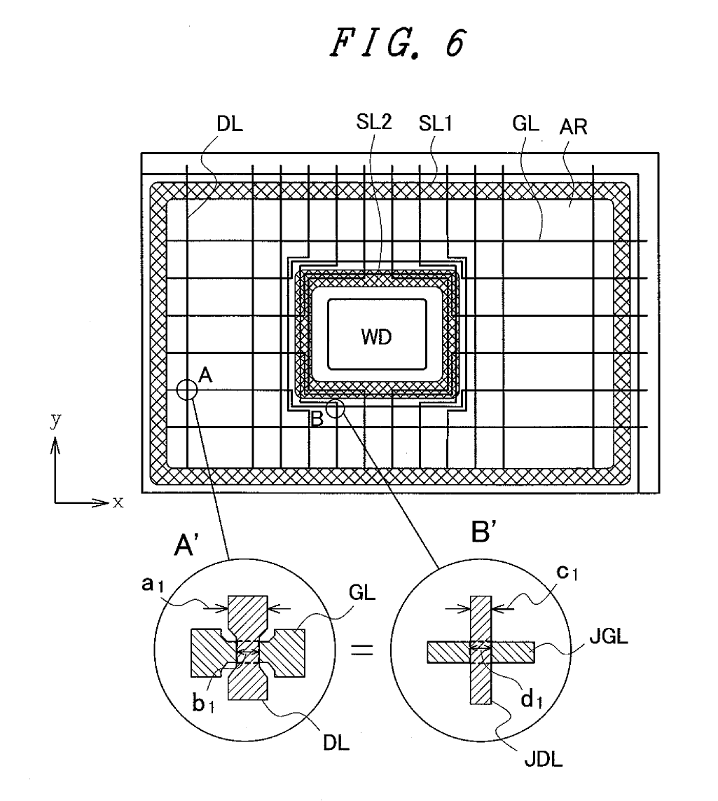

FIG. 6 is a view for explaining the schematic constitution of a liquid crystal display device of an embodiment 3 which is a display device to which the present invention is applied. FIG. 6 is also a view for explaining the schematic constitution of a region surrounded by a first sealing material SL1 and a second sealing material 2 in the liquid crystal display device of the embodiment 3.

In the liquid crystal display device of the embodiment 3, at an intersecting portion of a drain line DL and a gate line GL formed within a display region AR, as shown in an enlarged view A′ showing a portion indicated by a circle A in FIG. 6, respective line widths of the drain line DL and the gate line GL at the intersecting portion are set smaller than line widths of the respective lines DL, GL at portions other than the intersecting portion. In the embodiment 3, both line widths of the drain line DL and the gate line GL in an intersecting region are set smaller than the line widths of the drain line DL and the gate line GL at portions other than the intersecting portion. However, the present invention is not limited to such a constitution, and the line width of at least one of the drain line DL and the gate line GL at the intersecting portion may be set smaller than the line width of either one of the drain line DL and the gate line GL at portions other than the intersecting portion.

Here, as shown in an enlarged view B′ which shows a portion indicated by a circle B in FIG. 6, line widths of a drain route-around line JDL and a gate route-around line JGL at the intersecting portion formed in a peripheral region of a window potion WD are set smaller than line widths of the drain line DL and the gate line GL at non-intersecting portions, and the line widths of the respective route-around lines at the intersecting portion and the line width of the same route-around lines at portions other than the intersecting portion are set equal with respect to the route-around lines of the drain line DL and the gate line GL.

That is, in the liquid crystal display device of the embodiment 3, the line widths of the drain line DL and the gate line GL at the intersecting portion are narrowed so as to set an intersecting area at the intersecting portion of the drain line DL and the gate line GL within the display region AR and an intersecting area at the intersecting portion of the drain route-around line JDL and the gate route-around line JGL on the periphery of the window portion WD equal. For example, assuming a line width of the drain line DL at portions other than the intersecting region as a₁, a line width of the drain line DL in the intersecting region as b₁, a line width of the drain route-around line JDL at portions other than the intersecting region as c₁, a line width of the drain route-around line JDL in the intersecting region as d₁, a line width of the gate line GL at portions other than the intersecting region as a₂, a line width of the gate line GL in the intersecting region as b₂, a line width of the gate route-around line JGL at portions other than the intersecting region as c₂, and a line width of the gate route-around line JGL in the intersecting region as d₂, the respective line widths are determined so as to satisfy the relationship of b₁=c₁=d₁, and the relationship of b₂=c₂=d₂. Further, the drain line DL and the gate line GL, and the drain route-around line JDL and the gate route-around line JGL orthogonally intersect with each other in the intersecting region. Accordingly, it is possible to set intersecting-portion capacitance generated at the intersecting portion of the signal lines DL, GL within the display region AR and intersecting-portion capacitance generated at the intersecting portion of the route-around lines JDL, JGL within the periphery of the window portion WD equal.

As a result, even when the route-around lines (the drain route-around lines JDL and the gate route-around line JGL) are used along with the formation of the window portion WD, the in-plane effective voltage difference within the display region AR can be decreased thus reducing the brightness irregularities within the display region AR.

Further, as shown in the enlarged views A′ and B′, compared to the above-mentioned case in which the drain line DL and the gate line GL orthogonally intersect with each other and the drain route-around line JDL and the gate route-around line JGL orthogonally intersect with each other, there may be a case where the drain line DL, the gate line GL, the drain route-around line JDL and the gate route-around line JGL are formed such that the lines DL, GL do not intersect with each other orthogonally but intersect with each other obliquely, and the route-around lines JDL, JGL do not intersect with each other orthogonally but intersect with each other obliquely. In such a case, areas of intersecting regions are changed depending on an inclination angle even when the respective lines have the same line width. Accordingly, in the liquid crystal display device having such a constitution, the line widths may be determined by taking not only the line widths but also the inclination angle of the lines at the intersecting region into consideration. That is, the line widths may be determined by taking the line widths and the inclination angle of the drain route-around line JDL and the gate route-around line JGL in the intersecting region into consideration. Also in this case, in the same manner as the above-mentioned case where the respective lines orthogonally intersect with each other, even when the route-around lines (the drain route-around lines JDL and the gate route-around lines JGL) are used along with the formation of the window portion WD, it is possible to decrease the in-plane effective voltage difference within the display region AR thus reducing the brightness irregularities within the display region AR.

Further, the present invention is not limited to the case where the intersecting portion capacitance of the signal line in the display region AR and the intersecting portion capacitance of the route-around line on the periphery of the window portion WD are set equal. That is, the present invention is also applicable to a case where both intersecting portion capacitances are different from each other but are close to each other to an extent that brightness irregularities do not become conspicuous. Accordingly, the embodiment 3 is a modification of the embodiment 1 and hence, also in the embodiment 3, the line width of the drain line DL, the line width of the drain route-around line JDL at the intersecting portion, the line width of the gate line GL and the line width of the gate route-around line JGL may be set to any values provided that the formula 1 and/or the formula 2 of the embodiment 1 are/is satisfied.

Further, the present invention is also applicable to a display device which is formed by combining the liquid crystal display device of the embodiment 1 and the liquid crystal display device of the embodiment 3. In such a display device, as in the case of the liquid crystal display device of the embodiment 1, at the intersecting portion of the drain route-around line JDL and the gate route-around line JGL formed in the periphery of the window portion WD, the line widths of the respective round-about lines at the intersecting portion are set larger than the line widths of the respective round-around lines at portions other than the intersecting portion. Also in such a display device, as in the case of the liquid crystal display device of the embodiment 3, line widths of the respective intersecting portions may be changed such that, at the intersecting portion of the drain line DL and the gate line GL within the display region AR, the line widths of the respective signal lines at the intersecting portion are set smaller than the line widths of the respective signal lines at portions other than the intersecting portion, and an area of the intersecting portion of the route-around lines and an area of the intersecting portion of the signal lines within the display region AR is set equal to or close to each other.

Here, the present invention is not limited to the liquid crystal display device and is also applicable to a display device of other type such as an organic EL display device.

What is claimed is:

1. A display device comprising:
a plurality of drain lines and a plurality of gate lines intersecting with the drain lines on a substrate;
regions surrounded by the drain lines and the gate lines as regions of pixels;
wherein a non-display region where the drain lines, the gate lines and the pixels are not formed is formed at a portion within a display region which is constituted of a mass of the pixels,
drain route-around lines and gate route-around lines are formed by routing the drain lines and the gate lines separated by the non-display region around the non-display region,
a line width of at least one of the drain route-around line and the gate route-around line is set such that the line width at an intersecting portion where the drain route-around line and the gate route-around line intersect with each other differs from the line width at a non-intersecting portion, and
assuming the line width of the drain line at the non-intersecting portion as a₁, the line width of the drain line at the intersecting portion as b₁, the line width of the drain route-around line at the non-intersecting portion as c₁, the line width of the drain route-around line at the intersecting portion as d₁, the line width of the gate line at the non-intersecting portion as a₂, the line width of the gate line at the intersecting portion as b₂, the line width of the gate route-around line at the non-intersecting portion as c₂, and the line width of the gate route-around line at the intersecting portion as d₂, a relationship of |a₁−c₁|>|b₁−d₁| and/or a relationship of |a₂−c₂>|b₂−d₂| are/is established.

2. A display device comprising:
a plurality of drain lines and a plurality of gate lines intersecting with the drain lines on a substrate;
regions surrounded by the drain lines and the gate lines as regions of pixels;
wherein a non-display region where the gate lines, the drain lines and the pixels are not formed is formed at a portion within a display region which is constituted of a mass of the pixels,
drain route-around lines and gate route-around lines are formed by routing the drain lines and the gate lines separated by the non-display region around the non-display region, and
a line width of the drain route-around line and a line width of the gate route-around line at an intersecting portion where the drain route-around line and the gate route-around line intersect with each other are respectively set larger than the line width of the drain route-around line and the line width of the gate route-around line at portions other than the intersecting portion.

3. A display device according to claim 1, wherein one route-around line out of the drain route-around line and the gate route-around line is formed in a bent shape in a region where a plurality of intersecting portions is arranged, and another route-around line is formed in a non-bent shape in the region where the plurality of intersecting portions is arranged, and the intersecting portions arranged adjacent to each other on said one route-around line are displaced from each other in the extending direction of said another route-around line.

4. The display device according to claim 3, wherein said one route-around line is bent in a stepwise manner extending in one direction in the region where the plurality of intersecting portions is arranged.

5. The display device according to claim 3, wherein said one route-around line is bent in a zigzag manner in the region where the plurality of intersecting portions is arranged.

6. A display device comprising:
a plurality of drain lines and a plurality of gate lines intersecting with the drain lines on a substrate;
regions surrounded by the drain lines and the gate lines as regions of pixels;
wherein a non-display region where the gate lines, the drain lines and the pixels are not formed is formed at a portion within a display region which is constituted of a mass of the pixels,
drain route-around lines and gate route-around lines are formed by routing the drain lines and the gate lines separated by the non-display region around the non-display region,
a line width of the drain route-around line is smaller than a line width of the drain line,
a line width of the gate route-around line is set smaller than a line width of the gate line, and
the line width of the drain line and the line width of the gate line at an intersecting portion where the drain line and the gate line intersect with each other are respectively set smaller than the line width of the drain line and the line width of the gate line at portions other than the intersecting portion.

7. The display device according to claim 1, wherein the display device is a liquid crystal display device which includes another substrate arranged to face the substrate in an opposed manner with liquid crystal sandwiched therebetween,
the non-display region constitutes a window portion formed between the substrate and said another substrate and surrounded by a sealing material.

8. The display device according to claim 1, wherein the substrate has an opening at a position corresponding to the non-display region.
